(19) United States
(12) Patent Application Publication
(10) Pub. No.: US 2024/0219942 A1
(43) Pub. Date: Jul. 4, 2024

(54) DIGITAL CONTROL SYSTEM SUITABLE FOR LASER AND OPERATING METHOD THEREOF

(71) Applicant: Guangzhou Longhu Technology Development Co., Ltd., Guangzhou City (CN)

(72) Inventor: Peijian Xu, Guangzhou City (CN)

(21) Appl. No.: 18/602,993

(22) Filed: Mar. 12, 2024

(30) Foreign Application Priority Data
Mar. 14, 2023 (CN) 202310243095.9

(51) Int. Cl. G05D 25/02

(52) U.S. Cl. CPC G05D 25/02

(57) ABSTRACT

The present invention discloses a digital control system suitable for lasers and an operation method thereof, the digital control system comprises a controller and a laser, and the controller comprises a microprocessor, an input module, a monitoring module, a laser driving power module and a storage module; and the microprocessor performs data processing on received parameter data, index, parameter database and operating condition information to issue a corresponding control instruction to the laser by controlling the laser driving power module.

### TECHNICAL FIELD

The present invention pertains to the technical field of laser galvanometers, and more specifically pertains to a digital control system suitable for lasers and an operating method thereof.

### BACKGROUND

A galvanometer system is a high-precision, high-speed servo control system composed of a drive plate and a high-speed swing motor, and is widely used in the fields of laser material processing, biomedical detection, image graphic processing and the like.

Drive plate parameters of lasers in the existing galvanometer systems mainly comprises the following adjustment items: 1. total current adjustment; 2. total voltage adjustment; 3. laser on threshold point adjustment; and 4. laser on threshold point current compensation adjustment. Since existing laser drive devices generally use analog potentiometers to adjust voltage and current control, 3-4 precision potentiometers are required to adjust a laser. In addition, due to use of an analog adjustment mode, it is difficult to finely adjust the voltage because the precision potentiometer is a mechanical type with a low adjustment resolution, and resulting in significant power fluctuation upon fine adjustment of the voltage and failure to achieve desired output data. Therefore, professionals who have received certain professional training are required to make fine adjustment on the laser. Moreover, it is necessary to use a voltmeter to measure and adjust output ends one by one or to disassemble the laser to gradually adjust them according to actual effects, which is time-consuming and laborious, and failure to ensure consistency of multiple lasers, resulting in color effect deviation of the lasers after leaving the factory, and non-professional end users cannot adjust chromatic aberration by themselves.

### SUMMARY

The object of the present invention is to solve the disadvantages of the prior art, and therefore an operating method of a digital control system suitable for lasers is proposed, which effectively ensures consistency of the laser after leaving the factory, has characteristics such as easy modulation control, and allows ordinary users to adjust chromatic aberration by himself without worrying about that the lase cannot be recovered after improper adjustment.

In order to achieve the above object, the present invention is achieved by adopting the following technical solutions: there is provided an operating method of a digital control system suitable for lasers, the digital control system comprises a controller and a laser, the digital control system comprises a write mode, and an operating method of the write mode comprises the following steps:
step S1, upon enabling the write mode, inputting, by a user, a parameter instruction to the controller, and immediately performing, by the controller, data processing on the parameter instruction to convert the parameter instruction into a corresponding index;
step S2, performing, by the controller, data matching on the converted index and a prestored parameter database, wherein if the data matching is consistent, the controller calls the matched parameter data as a control instruction, and if the data matching is inconsistent, the controller does not output the control instruction; and
step S3, transmitting, by the controller, the control instruction to the laser, causing the laser to switch to a corresponding lighting action according to the control instruction.

Further, the digital control system comprises an edit mode, and an operating method of the edit mode comprises the following steps:
step A1, upon enabling the edit mode, inputting, by the user, a parameter instruction to the controller;
step A2, converting, by the controller, the received parameter instruction as a control instruction, and transmitting the converted control instruction to the laser, causing the laser to switch to a corresponding lighting action according to the control instruction; and
step A3, repeating the steps A1-A2 one or more times, inputting, by the user, an archiving instruction to the controller if the lighting action of the laser meets predetermined requirements, storing, by the controller, current parameter data in the parameter database, with the set of parameter data forming a unique index number.

Further, the digital control system comprises a monitor mode, and during operation of the laser, the controller always keeps the monitor mode enabled, and monitors and obtains operating condition information of the laser in real time, wherein if the real-time monitoring finds that operating condition of the laser is abnormal, the controller issues a control instruction to the laser for protection, causing the laser to switch to a proper state or stop operation.

A digital control system suitable for lasers, comprises a controller and a laser, and the controller comprises a microprocessor, an input module, a monitoring module, a laser driving power module and a storage module;
the microprocessor, the laser driving power module and the laser are electrically connected in sequence, wherein the laser driving power module is controlled by the microprocessor to issue a control instruction to the laser for light-on/light-off/power size/protection;
the microprocessor, the monitoring module and the laser are electrically connected in sequence, wherein the monitoring module is controlled by the microprocessor to acquire operating condition information of the laser in real time;
the input module, the microprocessor and the storage module are electrically connected in sequence, the input module is controlled by the microprocessor to directly transmit a parameter instruction input by a user to the microprocessor or convert the parameter instruction into a corresponding index, and the storage module is controlled by the microprocessor to store or call a parameter database; and
the microprocessor performs data processing on the received parameter data, index, parameter database and operating condition information to issue a corresponding control instruction to the laser by controlling the laser driving power module.

Further, the microprocessor is any of a CPU, a single chip microcomputer and a PLC.

The present invention has the following advantageous effects: by setting the write mode to convert the parameter input by the user into the corresponding index for data matching, the laser is instantaneously adjusted, and adjustment consistency of the lasers is effectively ensured, thus effectively solving the problem of requiring professionals for modulation, effectively lowering professional threshold for laser adjustment, and improving adjustment efficiency.

### BRIEF DESCRIPTION OF THE DRAWINGS

FIG. 1 is a composition diagram of a digital control system.

FIG. 2 is a flow diagram of a write mode.

FIG. 3 is a flow diagram of an edit mode.

### DESCRIPTION OF THE EMBODIMENTS

The technical solutions in the embodiments of the present invention will be clearly and completely described below in conjunction with the accompanying drawings in the embodiments of the present invention. Obviously, the embodiments described are only part but not all of the embodiments of the present invention. Based on the embodiments of the present invention, all other embodiments obtained by those of ordinary skill in the art without creative work shall fall within the protection scope of the present invention.

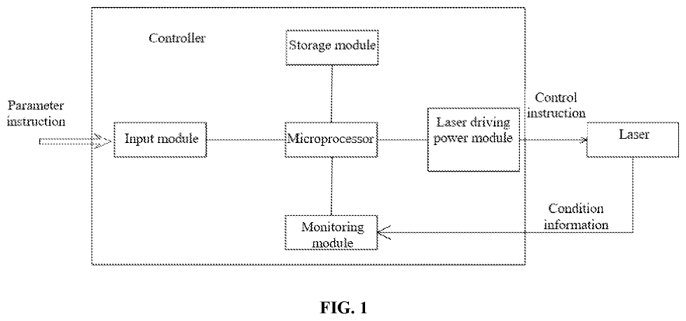

As shown in FIG. 1, in the present embodiment, there is provided an operating method of a digital control system suitable for lasers, the digital control system comprises a controller and a laser. Specifically, the controller of the present embodiment comprises a microprocessor, an input module, a monitoring module, a laser driving power module and a storage module.

In the present embodiment, the microprocessor, the laser driving power module and the laser are electrically connected in sequence, wherein the laser driving power module is controlled by the microprocessor to issue a control instruction to the laser for light-on/light-off/power level/protection, that is, a lighting action to which the laser switches according to the control instruction transmitted by the laser driving power module.

In the present embodiment, the microprocessor, the monitoring module and the laser are electrically connected in sequence, wherein the monitoring module is controlled by the microprocessor to acquire operating condition information of the laser in real time. That is, the monitoring module performs real-time acquisition monitoring of the operating condition information during operation of the laser, and the microprocessor performs data processing on the acquired operating condition information, so that a corresponding control instruction for protection can be issued in a timely and effectively manner in case of any laser abnormality, causing the laser to switch to a proper state or stop operation. Specifically, the monitoring module here may acquire the operating condition information of the laser through external sensor elements such as a temperature sensor, a current sensor and a voltage sensor, and transfer data of the acquired operating condition information to the microprocessor, and the microprocessor compares the data with a predetermined protection value according to various operating condition information, and if any of the operating condition information exceeds the predetermined protection value, the laser is abnormal.

In the present embodiment, the input module, the microprocessor and the storage module are electrically connected in sequence, and the input module is controlled by the microprocessor to directly transmit a parameter instruction input by a user to the microprocessor or convert the parameter instruction into a corresponding index. That is, the input module, as a user operation port, may input the parameter instruction in a write mode or an edit mode, wherein in the write mode, the input parameter instruction is converted into the corresponding index. In the edit mode, the input parameter instruction is directly transmitted to the microprocessor for data processing. The storage module is controlled by the microprocessor to store or call a parameter database, the data database contains a plurality of parameter data stored in the edit mode, and each parameter data has a unique index number. The microprocessor here may call the parameter database in the storage module to perform data matching based on the index formed by conversion, and if the index formed by the conversion is consistent with the index number of any of parameter data in the parameter database, the data matching is consistent, and the controller calls the matched parameter data as a control instruction; on the contrary, if the index formed by the conversion is inconsistent with the index number of any of the parameter data in the parameter database, the data matching is inconsistent, and the controller will not output the control instruction. This way of data matching can not only prevent the user from issuing wrong parameter instructions due to misoperation at an input end, but also reduce the difficulty of laser debugging. The user only needs to input a pre-set parameter instruction to issue a unique control instruction to the laser, allowing the laser to be instantaneously adjusted through simple adjustment, especially for non-professional personnel, and greatly improving the problems of necessity of professionals for debugging of conventional lasers and tedious and time-consuming operation.

In summary, the microprocessor performs data processing on the received parameter data, index, parameter database and operating condition information to issue the corresponding control instruction to the laser by controlling the laser driving power module.

In order to facilitate an understanding of the digital control system described above, a further explanation is provided below in connection with a specific operating method.

The digital control system comprises a write mode, an edit mode, and a monitor mode. The write mode acts as a resident mode in the daily use of the laser, while the edit mode acts as a non-resident mode for professionals to debug or increase the parameter data in the parameter database. In this case, the edit mode requires addition of permission keys in actual production to effectively prevent the possibility of misoperation.

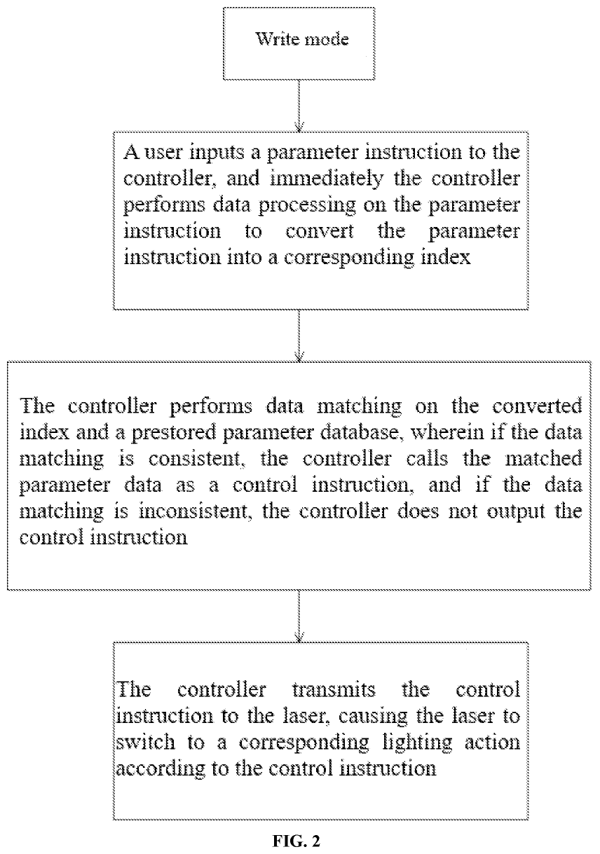

Specifically, as shown in FIG. 2, an operating method of the write mode of the present embodiment comprises the following steps:
Step S1, upon enabling the write mode, inputting, by a user, a parameter instruction to the controller, and immediately performing, by the controller, data processing on the parameter instruction to convert the parameter instruction into a corresponding index; that is, the user inputs a parameter instruction by the input module, and then the input module performs data processing on the parameter instruction to convert the parameter instruction into the corresponding index, and then transfer the converted index to the microprocessor for data processing.
Step S2, performing, by the controller, data matching on the converted index and a prestored parameter database, wherein if the data matching is consistent, the controller calls the matched parameter data as a control instruction, and if the data matching is inconsistent, the controller does not output the control instruction; that is, the microprocessor calls the parameter database in the storage module to perform data matching with the converted index, and if the converted index matches an index number of any of parameter data in the parameter database, the matched parameter data is called as a control instruction.
Step S3, transmitting, by the controller, the control instruction to the laser, causing the laser to switch to a corresponding lighting action according to the control instruction; that is, the microprocessor transfers the called parameter data to the laser driving power module as a control instruction which is transmitted to the laser by the laser driving power module, thereby causing the laser to switch to a corresponding lighting action.

Further, in the step S2, if the data matching is inconsistent, in this case, the microprocessor will not control the laser driving power module to issue any control instruction to the laser, meaning that the parameter instruction input by the user is not the prestored parameter data, and is an erroneous input, thus effectively preventing misoperation; in this case, as long as the user inputs a predetermined parameter instruction, the data matching consistent, the laser may be adjusted according to the predetermined parameter data, which effectively lowers the threshold and difficulty of the production and use of the laser, and allows non-professional personnel to complete a lighting operation.

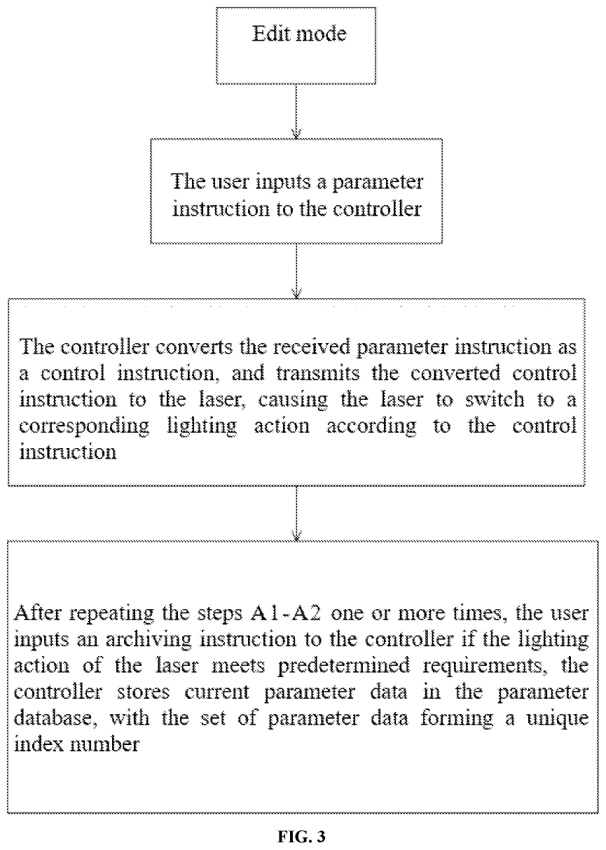

Specifically, as shown FIG. 3, an operating method of the edit mode of the present embodiment comprises the following steps:
Step A1, upon enabling the edit mode, inputting, by the user, a parameter instruction to the controller; that is, the user inputs the parameter instruction by the input module.
Step A2, converting, by the controller, the received parameter instruction as a control instruction, and transmitting the converted control instruction to the laser, causing the laser to switch to a corresponding lighting action according to the control instruction; that is, the input module transmits the input parameter instruction to the microprocessor for data processing, and the microprocessor converts the parameter instruction as a control instruction which is transmitted by the laser driving power module to the laser, causing the laser to switch to a corresponding lighting action.
step A3, repeating the steps A1-A2 one or more times, inputting, by the user, an archiving instruction to the controller if the lighting action of the laser meets predetermined requirements, storing, by the controller, current parameter data in the parameter database, with the set of parameter data forming a unique index number. That is, when the user observes that the lighting action of the laser meets requirements, an archiving instruction may be input by the input module, and the microprocessor performs data processing on the current parameter data to be packed and stored in the parameter database in the storage module, and the parameter data forms a unique index number to facilitate data matching in the write mode.

Further, through the step A3, a function of supplementing the parameter database may be realized, allowing adjustment option of the laser to be wider, and supplementing operation to be simple and independent.

In the present embodiment, during operation of the laser, the controller always keeps the monitor mode enabled, and monitors and obtains operating condition information of the laser in real time, wherein if the real-time monitoring finds that operating condition of the laser is abnormal, the controller issues a control instruction to the laser for protection, causing the laser to switch to a proper state or stop operation. That is, the monitoring module transfers and transmits the operating condition information of the laser acquired in real time to the microprocessor for data processing, the microprocessor compares the received operating condition information with a predetermined protection value; if any of the operating condition information exceeds the predetermined protection value, the laser is abnormal, and the microprocessor controls the laser driving power module to issue a control instruction for protection to the laser, and the laser switches to a proper state or stops operation. In this way, it is possible to effectively prevent the laser from being burned out due to abnormal operation.

Further, the microprocessor described above is any of a CPU, a single chip microcomputer and a PLC, thus solving the problem of inaccuracy of the conventional analog control method, and the laser is digitally controlled by the microprocessor, thereby achieving fine control of the voltage in millivolt level.

The above merely describes specific embodiments of the present invention, but the protection scope of the present invention is not limited thereto. Changes or replacements easily conceived by any person skilled in the art within the technical scope disclosed in the present invention all fall within the protection scope of the present invention. Therefore, the protection scope of the present invention should be subject to the protection scope of the claims.

What is claimed is:

1. An operating method of a digital control system suitable for lasers, the digital control system comprising a controller and a laser, wherein the digital control system comprises a write mode, and an operating method of the write mode comprises the following steps:
step S1, upon enabling the write mode, inputting, by a user, a parameter instruction to the controller, and immediately performing, by the controller, data processing on the parameter instruction to convert the parameter instruction into a corresponding index;
step S2, performing, by the controller, data matching on the converted index and a prestored parameter database, wherein if the data matching is consistent, the controller calls the matched parameter data as a control instruction, and if the data matching is inconsistent, the controller does not output the control instruction; and
step S3, transmitting, by the controller, the control instruction to the laser, causing the laser to switch to a corresponding lighting action according to the control instruction.

2. The operating method according to claim 1, wherein the digital control system comprises an edit mode, and an operating method of the edit mode comprises the following steps:
step A1, upon enabling the edit mode, inputting, by the user, a parameter instruction to the controller;
step A2, converting, by the controller, the received parameter instruction as a control instruction, and transmitting the converted control instruction to the laser, causing the laser to switch to a corresponding lighting action according to the control instruction; and
step A3, repeating the steps A1-A2 one or more times, inputting, by the user, an archiving instruction to the controller if the lighting action of the laser meets predetermined requirements, storing, by the controller, current parameter data in the parameter database, with the set of parameter data forming a unique index number.

3. The operating method according to claim 2, wherein the digital control system comprises a monitor mode, and during operation of the laser, the controller always keeps the monitor mode enabled, and monitors and obtains operating condition information of the laser in real time, wherein if the real-time monitoring finds that operating condition of the laser is abnormal, the controller issues a control instruction to the laser for protection, causing the laser to switch to a proper state or stop operation.

4. A digital control system suitable for lasers, comprising a controller and a laser, wherein
the controller comprises a microprocessor, an input module, a monitoring module, a laser driving power module and a storage module;
the microprocessor, the laser driving power module and the laser are electrically connected in sequence, wherein the laser driving power module is controlled by the microprocessor to issue a control instruction to the laser for light-on/light-off/power size/protection;
the microprocessor, the monitoring module and the laser are electrically connected in sequence, wherein the monitoring module is controlled by the microprocessor to acquire operating condition information of the laser in real time;
the input module, the microprocessor and the storage module are electrically connected in sequence, the input module is controlled by the microprocessor to directly transmit a parameter instruction input by a user to the microprocessor or convert the parameter instruction into a corresponding index, and the storage module is controlled by the microprocessor to store or call a parameter database; and
the microprocessor performs data processing on the received parameter data, index, parameter database and operating condition information to issue a corresponding control instruction to the laser by controlling the laser driving power module.

5. The digital control system according to claim 4, wherein the microprocessor is any of a CPU, a single chip microcomputer and a PLC.
